(19) United States
(12) Patent Application Publication
(10) Pub. No.: US 2019/0347583 A1
(43) Pub. Date: Nov. 14, 2019

(54) CUSTOMIZING TRAVEL ITINERARIES BASED ON TRAVEL BEHAVIOR AND NON-TRAVEL BEHAVIOR

(71) Applicant: Travel Boss, Inc., Austin, TX (US)

(72) Inventors: Matt Pfeil, Austin, TX (US); Nicholas Bailey, Austin, TX (US)

(21) Appl. No.: 15/979,261

(22) Filed: May 14, 2018

(51) Int. Cl. G06Q 10/02; G06Q 10/04

(52) U.S. Cl. CPC G06Q 10/025; G06Q 10/047

(57) ABSTRACT

A system creates a customized travel itinerary for a user based on travel and non-travel patterns of behavior. For example, the system identifies schedule data (e.g., including a time and a locating) for an event associated with the user, and determines at least one travel preference based on a pattern of travel behavior. The system also monitors non-travel behavior of the user for a time period to determine a pattern of non-travel behavior, and determines at least one predicted travel preference for the user based on the pattern of non-travel behavior. The system further determines a set of travel preferences that includes the at least one travel preference and the at least one predicted travel preference, and generates a travel itinerary based on the schedule data and the set of travel preferences.

### BACKGROUND OF THE INVENTION

### Field of the Invention

The present disclosure generally relates to travel services, and more particularly, to customizing travel itineraries based on travel behavior and non-travel behavior.

### Description of the Related Art

Before our modem information age, travelers often booked a trip through a third party such as a travel agent. In this fashion, travel agents served as a broker between travel service providers (e.g., airlines, hotels, car rentals, etc.) and potential travelers. As technology improved, travel service providers began to directly offer products and services online. However, with widespread consumer access and a relatively low cost to provide content online, travelers have become inundated with an ever-increasing amount of information. While is it possible for travelers to quickly access and reserve travel services online, travelers are often overwhelmed by the amount of information, available options, promotional offerings, advertisements, and so on. Certain challenges arise due to this ever-increasing volume of information. For example, it is increasingly difficult for travel service providers to meaningfully connect with potentially interested travelers and likewise, it is increasingly burdensome for travelers to efficiently evaluate, prioritize, filter, and reserve travel services.

In addition, many travel services currently rely on direct customer input to create a travel itinerary and reserve travel services. Accordingly, travel itineraries are often customizable in proportion to an amount of time and effort expended by the traveler to manually provide inputs, select options, and so on. However, many travel itineraries fail to capture or satisfy traveler preferences due to the onerous and time-consuming nature to manually provide input, filter relevant travel services, evaluate numerous options, and the like. In addition, some traveler preferences may be subtle and/or difficult to directly solicit from customers. However, adoption of modern technology in everyday life provides new opportunities to obtain insights regarding such subtle consumer preferences. Therefore, there is a need in the art to improve travel experiences, identify customer preferences, and customize travel itineraries.

### SUMMARY

This disclosure generally describes techniques to create a customized travel itinerary based on travel preferences derived from patterns of travel and non-travel behavior. In one embodiment, these techniques are described by a method that includes a step to identify schedule data (e.g., including a time, a location, etc.) for an event associated with a user and a step to determine at least one travel preference based on a pattern of travel behavior. For example, the pattern of travel behavior can indicate preferences for a particular airline, hotel preferences, a rewards program, a seat selection, and so on. The method also includes a step to monitor non-travel behavior of the user for a time period to determine a pattern of non-travel behavior and a step to determine at least one predicted travel preference for the user based on the pattern of non-travel behavior. For example, the non-travel behavior can indicate daily or routine preferences for retailers, coffee shops, fitness regimes (e.g., running or walking outside, near a park, etc.), and so on. The method also provides steps to determine a set of travel preferences that includes the at least one travel preference and the at least one predicted travel preference, and generate a travel itinerary for the event based on the schedule data and the set of travel preferences. Notably, the travel itinerary includes one or more services that facilitate attendance at the event. The method also includes a step to reserve the one or more services for the user, which may be an automatic process or a user directed process.

In another embodiment, a travel itinerary system employs the above discussed techniques to create a customized travel itinerary. In this embodiment, the travel itinerary system includes a network interface to communicate over one or more communication networks, a processor coupled to the network interface and adapted to execute one or more processes, and a memory configured to store a process executable by the processor. The process is operable to identify schedule data (e.g., including a time and a location) for an event associated with a user, and determine at least one travel preference based on a pattern of travel behavior. In addition, the process is further operable to monitor non-travel behavior of the user for a time period to determine a pattern of non-travel behavior, determine at least one predicted travel preference for the user based on the pattern of non-travel behavior, and determine a set of travel preferences that includes the at least one travel preference and the at least one predicted travel preference. The process also generates a travel itinerary for the event based on the schedule data and the set of travel preferences and reserves services for the user to facilitate attendance at the event.

In yet another embodiment, a tangible, non-transitory, computer-readable media includes software with encoded instructions executable by a processor. The processor executes the instructions and is operable to identify schedule data (e.g., including a time and a location) for an event associated with a user, and determine at least one travel preference based on a pattern of travel behavior. In addition, the processor monitors non-travel behavior of the user for a time period to determine a pattern of non-travel behavior, and determines at least one predicted travel preference for the user based on the pattern of non-travel behavior. The processor further determines a set of travel preferences that includes the at least one travel preference and the at least one predicted travel preference. The processor also generates a travel itinerary for the event based on the schedule data and the set of travel preferences, and reserves services for the user (e.g., to facilitate attendance at the event).

### BRIEF DESCRIPTION OF THE DRAWINGS

FIG. 1 illustrates a schematic diagram of an example communication network;

FIG. 2 illustrates a block diagram of an example device configured to perform travel itinerary processes/services according to one embodiment of this disclosure;

FIG. 3 illustrates a schematic diagram of an example itinerary module, including sub-modules such as a preferences module, a scheduling module, and a personalization module;

FIG. 4 illustrates a schematic diagram of the personalization sub-module shown in FIG. 3;

FIG. 5 illustrates a schematic diagram of a travel management module that operates in conjunction with the itinerary module shown in FIG. 3; and

FIG. 6 illustrates an example procedure for creating a customized travel itinerary based on travel behavior and non-travel behavior.

### DETAILED DESCRIPTION

As used herein, the terms “user”, “customer”, and/or “traveler” refer to a user of an electronic device(s) and actions performed by the user in the context of computer software shall be considered to be actions to provide an input to electronic device(s) that cause the electronic device to perform steps or operations embodied in computer software.

As discussed above, when planning an itinerary, travelers are often overwhelmed by the amount of information, available options, promotional offerings, advertisements, and the like. Moreover, many travel services create travel itineraries based on direct customer input, which often fails to appreciate or solicit subtle customer preferences. In addition, while modern technologies support a shift from traditional travel agents to direct booking (e.g., using online services, etc.), traditional expertise and local experience from travel agents is often lost in the process. For example, travel agents often have unique knowledge (e.g., so called “tribal knowledge”) about travel service providers, destinations, local customs, and the like, and use this unique knowledge to develop a personalized travel itinerary. Although some travel service providers attempt to bridge this gap and provide such unique knowledge, travelers are often overwhelmed with information (as mentioned), which complicates attempts to aggregate data from many sources and navigate disparate travel sites.

Accordingly, many travel itineraries fail to capture or satisfy traveler preferences and/or fail to account for unique knowledge and travel expertise previously provided by a travel agent. As described herein, this disclosure provides improved techniques to customize travel itineraries based on travel preferences derived from patterns of travel and non-travel behavior. These techniques may be incorporated as part of an automated system that can access calendar data, monitor travel and non-travel behavior, integrate with a variety of travel service platforms (e.g., using Application Programming Interfaces (APIs), and reserve certain travel services based on travel preferences.

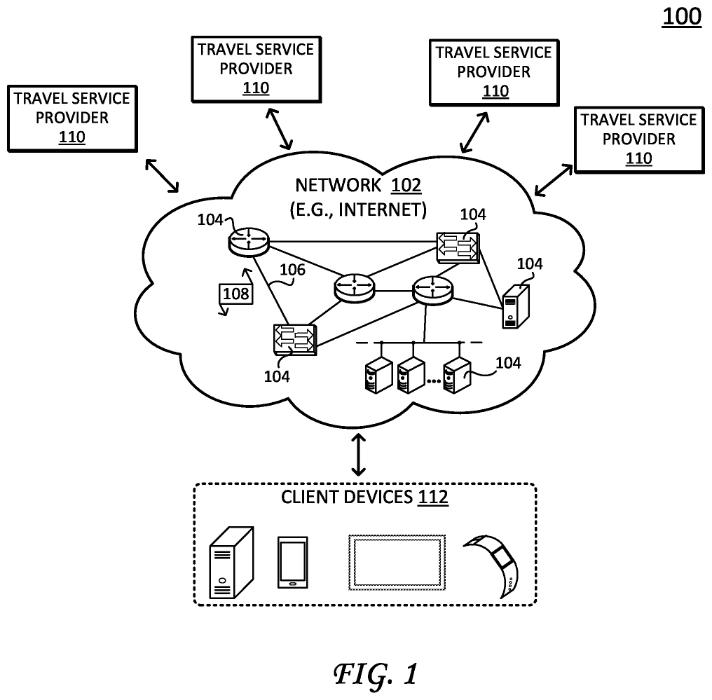

Referring to the figures, FIG. 1 illustrates a schematic diagram of an example communication environment 100. As shown, communication environment 100 includes a communication network 102 that represents a distributed collection of devices/nodes 104 interconnected by communication links 106 (and/or network segments) for exchanging data such as data packets 108 as well as transporting data to/from content providers, such as travel service providers 110, and end nodes or client devices 112. Client devices 112 include personal computing devices, laptops, tablets, mobile devices, and the like.

Notably, the content provided by travel service providers 110 can include information directly related to travelling (e.g., scheduling, reservations, etc.) as well as metadata from 3rd party providers that help aggregate and/or optimize certain travel preferences (e.g., seat selection, room placement, etc.).

Communication links 106 represent wired links or shared media links (e.g., wireless links, PLC links, etc.) where certain devices/nodes (e.g., routers, servers, switches, client devices, etc.) communicate with other devices/nodes, based on distance, signal strength, operational status, location, etc. Those skilled in the art will understand that any number of nodes, devices, links, etc. may be included in communication network 102, and further the view illustrated by FIG. 1 is provided for purposes of discussion, not limitation.

Data packets 108 represent network traffic/messages which are exchanged over communication links 106 and between network devices using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the devices or nodes interact with each other.

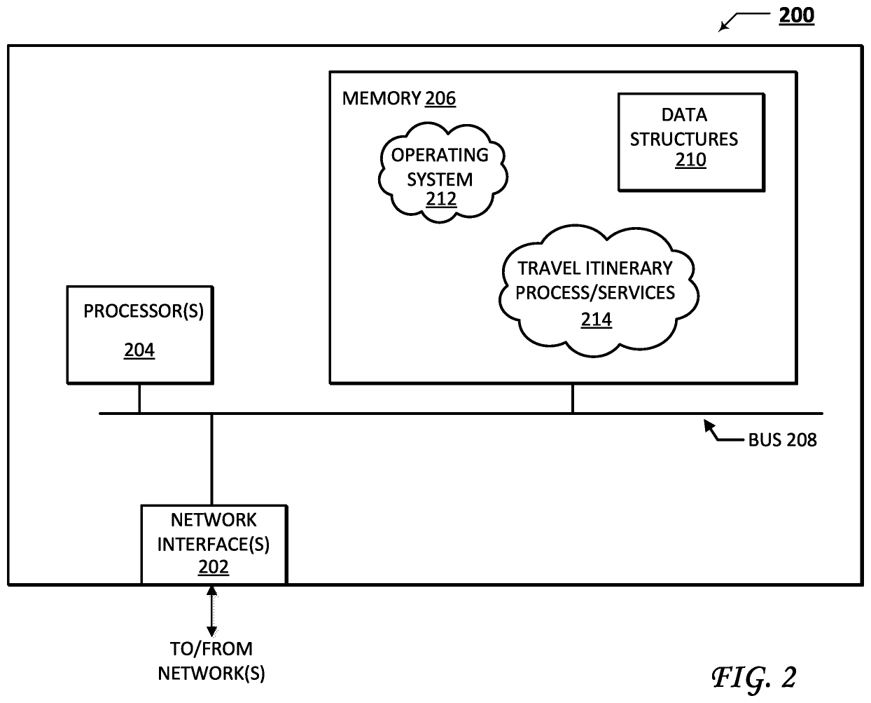

FIG. 2 illustrates a block diagram of an example device 200, which may represent one or more of devices 104 and/or client devices 112 (or portions thereof). As shown, device 200 includes one or more network interfaces 202 (e.g., transceivers, antennae, etc.), at least one processor 204, and a memory 206 interconnected by a system bus 208.

Network interface(s) 202 contain the mechanical, electrical, and signaling circuitry for communicating data over communication links 106 shown in FIG. 1. Network interfaces 202 are configured to transmit and/or receive data using a variety of different communication protocols, as will be understood by those skilled in the art.

Memory 206 comprises a plurality of storage locations that are addressable by processor 204 and store software programs and data structures associated with the embodiments described herein. For example, memory 206 can include a tangible (non-transitory) computer-readable medium, as is appreciated by those skilled in the art.

Processor 204 represents components, elements, or logic adapted to execute the software programs and manipulate data structures 210, which are stored in memory 206. An operating system 212, portions of which are typically resident in memory 206, and is executed by processor 204 to functionally organizes the device by, inter alia, invoking operations in support of software processes and/or services executing on the device. These software processes and/or services may comprise an illustrative travel itinerary process/service 214. Note that while travel itinerary process/service 214 is shown in centralized memory 206, it may be configured to collectively operate in a distributed communication network of devices/nodes.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 204 can include one or more programmable processors, e.g., microprocessors or microcontrollers, or fixed-logic processors. In the case of a programmable processor, any associated memory, e.g., memory 206, may be any type of tangible processor readable memory, e.g., random access, read-only, etc., that is encoded with or stores instructions that can implement program modules, e.g., a module having travel itinerary process 214 encoded thereon. Processor 204 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

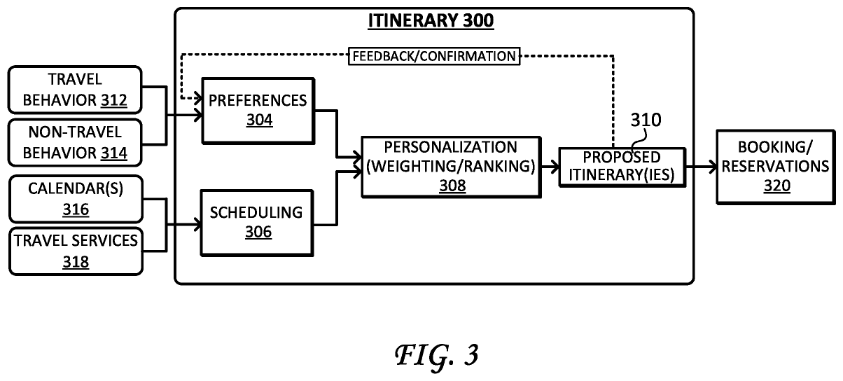

FIG. 3 illustrates a schematic diagram of an itinerary module 300, which may represent a component part of and/or operations performed by device 200. Itinerary module 300 includes a number of sub-modules such as a preferences module 304, a scheduling module 306, and a personalization module 308. Itinerary module 300 generally orchestrates the creation of a customized travel itinerary(ies) and may also act as a booking agent to reserve travel services (e.g., booking/reservations 320). For example, itinerary module 300 monitors information related to travel behavior 312, non-travel behavior 314, calendars 316, and travel services 318. As discussed in greater detail below, itinerary module 300 determines preferences 304 and scheduling 306 based on the monitored information, applies a personalization 308, and generates a proposed itinerary(ies) 310.

In detail, preferences module 304 monitors travel behavior 312 and non-travel behavior 314 to determine travel preferences (which may include predicted travel preferences). Travel behavior 312 relates to any actions, transactions, or behaviors related to traveling. For example, travel behavior 312 can include information related to travel service purchase prices, rewards programs, travel points, airline selections, seating assignments, checked bag options, trip extras, meals ordered, restaurants frequented, hotel bookings, and so on. In addition, travel behavior 312 can also include more granular information such as overhead bin spaces for aircraft configurations, WiFi availability, locations of hotel rooms (e.g., courtyard facing, etc.), hotel room configurations (e.g., king bed v. double beds, etc.), lodging amenities (e.g., spa, gym, hotel retail shops, etc.), prior lodging locations relative to certain stores, shops, parks, and the like, financial transactions for prior trips (e.g., from financial statements), total average travel times, arrival time selections, departure time selections, average local traffic at arrival/departure, transportation selections (e.g., taxi rides, public transit, car rental, etc.), transportation rates (e.g., surge rates, etc.) and so on.

As mentioned, preferences module 304 also monitors non-travel behavior 314, which includes information related to actions, transactions, or behaviors outside of a trip (e.g., when a user is not following a travel itinerary). This information can represent daily behavior or routines and may include, for example, meals ordered, transactions for a particular store, restaurant, office, and the like, fitness routines, health data, GPS data (e.g., locations and daily movements of a user), and so on.

Preferences module 304 compiles the information from both travel behavior 312 and non-travel behavior 314 and determines a set of travel preferences. For example, preferences module 304 may perform pattern recognition processes on the travel behavior 312 and non-travel behavior 314 to determine a set of travel preferences, which can include predicted travel preferences as well as travel preferences manually input and/or confirmed by a user. As an example, preferences module 304 may identify a specific airline as a preferred airline, hotel, or other company/brand if a user has an associated rewards account, often selects the airline/hotel/etc., has a high frequency of financial transactions for the company/brand, and so on.

Scheduling module 304 monitors information related to calendar(s) 316 to identify, for example, travel events, as well as information related to available travel services 318 (e.g., reservation availability such as seats, rooms, etc.). Scheduling 306 determines scheduling information based on the calendar information (from calendars 316), which includes one or more travel events, and the available travel services (from travel services 318) that support attendance for the travel event(s).

The travel preferences and scheduling information are further sent to personalization module 308, which generates one or more proposed itineraries 310 based on the available travel services and the travel preferences. In this fashion, personalization module 308 filters the identified travel services based on the travel preferences to identify the “best-fit” for services that closely match/satisfy the travel preferences. Personalization module 308 compiles the identified travel services into one or more proposed itineraries 310. In some embodiments, the proposed itineraries 310 are presented to a user for further confirmation, while in other embodiments the proposed itineraries are simply filtered and automatically booked. In this fashion, booking/reservations module 306 can receive confirmation from the user to book appropriate travel services and/or it may be configured to automatically book appropriate travel services.

Itinerary module 300 also includes a feedback mechanism “feedback/confirmation” whereby a user's selection of one or more proposed itineraries is used to confirm, remove, or adjust travel preferences for subsequent itinerary planning.

While the above described operations by itinerary module 300 support direct travel booking processes such as generating proposed itineraries actions to book/reserve travel arrangements, itinerary module 300 may also be adapted to support indirect travel processes. For example, itinerary module 300 may automate enrollment into rewards programs to maximize points in a travel rewards program, credit card selections for non-travel purchases (e.g., daily purchases) to optimize or maximize points for the rewards program, and so on.

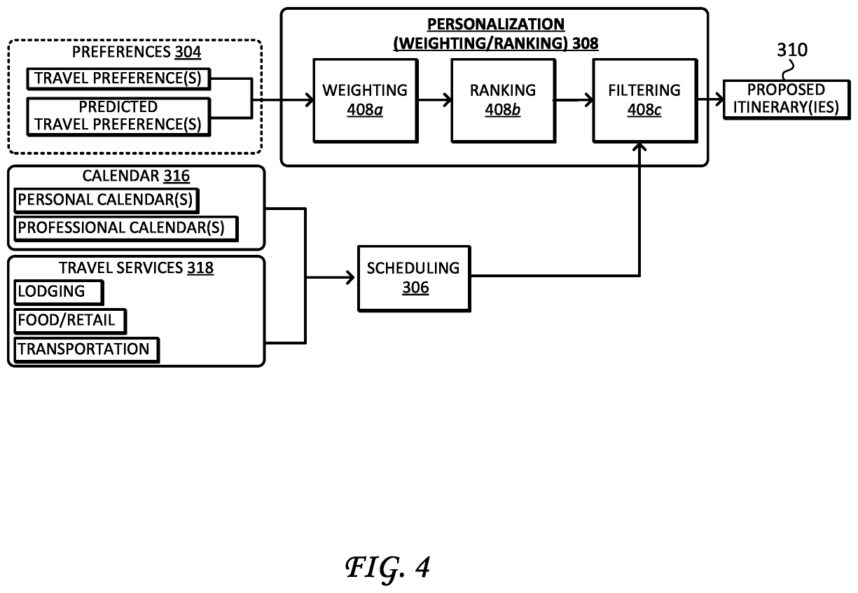

FIG. 4 illustrates a schematic diagram of personalization module 308, showing a weighting module 408a, a ranking module 408b, and a filtering module 408c. Recall, preferences module 304 determines travel preferences—here, travel preference(s) and predicted travel preference(s)—based on the travel behavior 312 and the non-travel behavior 314 and sends the travel preferences to personalization module 308. Scheduling module 306 identifies the services that satisfy event criteria/requirements (e.g., facilitate attendance at a particular location for a given time) and sends the services to personalization module 308.

As shown, personalization module 308 receives the travel preferences at weighting module 408a and receives the services at filtering module 408c. In operation, weighting module 308 assigns or applies a ranking to each travel preference (e.g., based on respective values). Ranking module 408b identifies a set of travel preferences for filtering the services (e.g., from scheduling module 306) based on the ranking. For example, some travel preferences from preferences module 304 may be more meaningful (e.g., holds more weight) to a user over others—e.g., it may be more important to a user to fly with a certain airline than it is for the user to arrive at a location at a specific time of day. Collectively, weighting module 408a and ranking module 408b assigns values and/or weights to respective travel preferences and applies a ranking to determine a set of travel preferences which is used by filtering module 408c to filter the services from scheduling module 306 and generate one or more proposed travel itinerary(ies) 310.

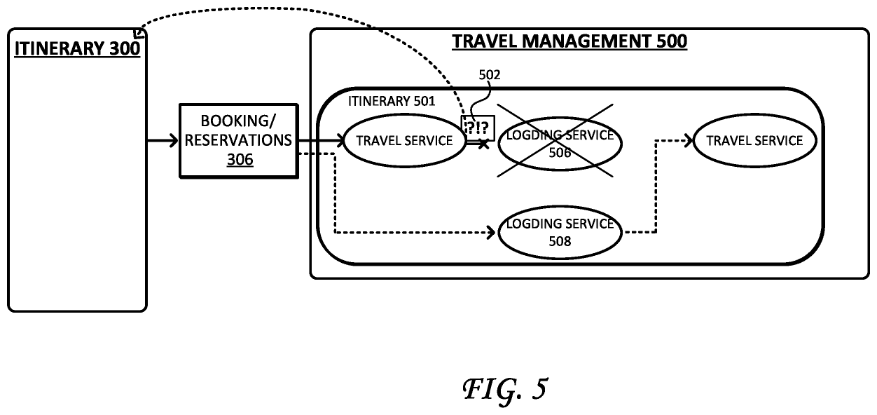

FIG. 5 illustrates a schematic diagram of a travel management module 500, which operates in conjunction with itinerary module 300. Travel management module 500 generally monitors activity for a current travel itinerary and automatically triages any issues as they arise. In particular, travel management module 500 monitors reservations for services during a current travel itinerary and will automatically book new services to mitigate any service disruption. Put differently, travel management module 500 monitors services during a travel itinerary for service changes such as potential or actual disruptions, cancellations, delays, and the like. When detected, these service changes trigger travel management module 500 to call itinerary module 300 to identify substitute services that will mitigate the service changes. For example, if an airline cancels a flight during an itinerary, travel management module 500 will automatically call itinerary module 300 to determine a new service (e.g., a new flight) to minimize travel delays.

Likewise, and as illustrated in FIG. 5, travel management module 500 can book a new hotel based on service changes at a current hotel (e.g., overbooked, reservations canceled, etc.) Here, travel management module 500 monitors a travel itinerary 501 and detects a service change 502. Service change 502 represents a hotel (e.g., lodging service 506) that cancels a reservation. Service change 502 triggers travel management module 500 to call itinerary module 300 to identify a new lodging service (e.g., lodging service 508) as a substitute for the canceled hotel. Travel management module 500 (and/or booking/reservation module 320) may present the new service to a user and solicit user confirmation prior to booking, or it may automatically book the new service.

While travel management module 500 is illustrated as a separate component from itinerary module 300 it is appreciated such view is shown for purposes of illustration, not limitation. It is appreciated functionality of each module may be included (or excluded) in other modules as desired.

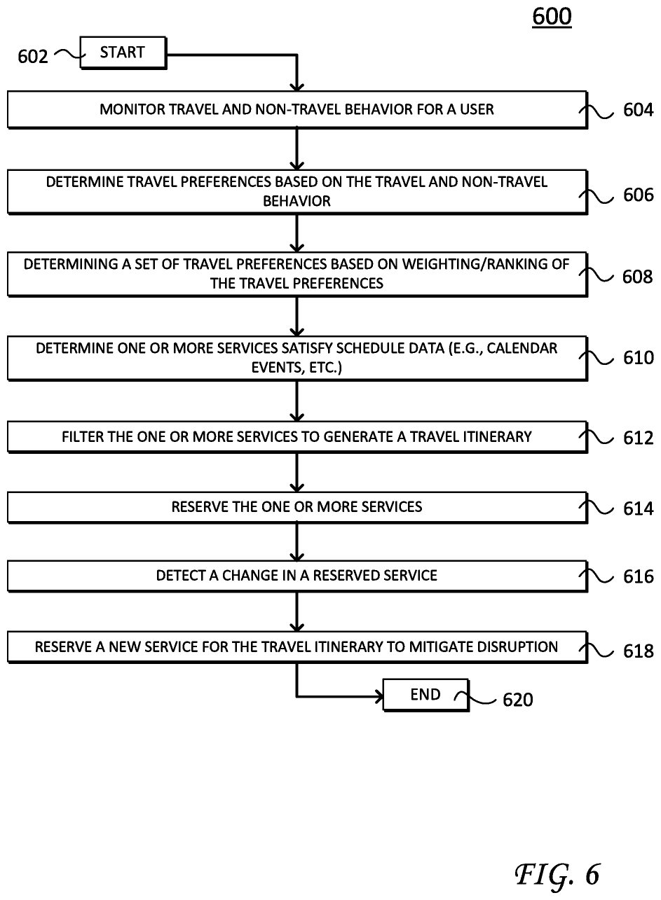

FIG. 6 illustrates an example simplified procedure 600 for creating a customized travel itinerary, particularly from the perspective of itinerary module 300 and/or travel management module 500.

Procedure 600 begins at step 602 and continues to step 604 where, as discussed above, itinerary module 300 monitors travel and non-travel behavior for a user and determines, at step 606, preferences (and/or predicted preferences) based on patterns of such behavior. Itinerary module 300 further determines, at step 608, a set of travel preferences from these preferences based on a weighting/ranking, as discussed above. Itinerary module 300 also determines, at step 610, one or more services that satisfy schedule data (e.g., calendar events, etc.). Put differently, itinerary module 300 can receive calendar data for a user (e.g., professional calendar data, personal calendar data, etc.) and determine schedule data from events in the calendar data. The schedule data may include information such as a date or a time of the event. Itinerary module 300 can parse through the calendar data to identify schedule data and further identify services that satisfy the schedule data (e.g., facilitate attendance at the event).

Itinerary module 300 further filters the services at step 612 based on the set of travel preferences (e.g., including respective ranking, weighting, etc.). The top or “best-fit” services that closest satisfy the schedule data and the travel preferences are then selected for inclusion on a proposed travel itinerary (or proposed travel itineraries). Itinerary module 300 may further reserve the services for the proposed travel itinerary. In addition, as mentioned above, itinerary module 300 and/or other modules such as travel management module 500 further monitor the reserved services and detect, at step 616, a change such as a disruption, a cancellation, a delay, etc. This change triggers itinerary module 300 and/or travel management module 500 to find a new service to mitigate the change (e.g., a substitute service, a change in an airline, a change in an airport, a change in seating, etc.) Procedure 600 subsequently ends at step 620, but may continue on to step 604 where, as discussed above, itinerary module 300 monitors travel and non-travel behavior for a user.

It should be noted some steps within procedure 600 may be optional, and further the steps shown are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, describe operations to create a customized travel itinerary based on travel and non-travel behavior. These operations also include ongoing support where a monitoring agent or module detects changes in a service for an itinerary and automatically performs triage operations (e.g., booking new services to mitigate the changes/disruption, etc.) While there have been shown and described illustrative embodiments to create a customized travel itinerary using particular devices, modules, sub-modules, etc., it is to be understood that various other adaptations and modifications may be made within the spirit and scope of the embodiments herein. For example, the embodiments have been shown and described herein with relation to certain systems, platforms, devices, and modules performing specific operations. However, the embodiments in their broader sense are not as limited, and may, in fact, such operations and similar functionality may be performed by any combination of the devices shown and described.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories such as disks, CDs, RAM, and EEPROM having program instructions executing on a computer, hardware, firmware, or a combination thereof.

Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code.

Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on.

Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures.

Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method for creating a customized travel itinerary, the method comprising:
identifying schedule data for an event associated with a user, the schedule data including information that corresponds to a time of the event and a location of the event;
determining at least one travel preference based on a pattern of travel behavior;
monitoring non-travel behavior of the user for a time period to determine a pattern of non-travel behavior;
determining at least one predicted travel preference for the user based on the pattern of non-travel behavior;
determining a set of travel preferences that includes the at least one travel preference and the at least one predicted travel preference;
generating a travel itinerary for the event based on the schedule data and the set of travel preferences, the travel itinerary identifying one or more services that facilitate attendance at the event; and
reserving the one or more services for the user.

2. The method of claim 1, further comprising:
confirming the at least one predicted travel preference to determine a new travel preference, and
wherein the set of travel preferences includes the new travel preference.

3. The method of claim 1, wherein the set of travel preferences includes a plurality of travel preferences, the method further comprising:
applying a ranking to the set of travel preferences based on respective values associated with each travel preference; and
determining the set of travel preferences based on the ranking.

4. The method of claim 3, wherein generating the travel itinerary for the event further comprises:
identifying a plurality of services that satisfy at least a portion of the set of travel preferences; and
selecting one or more of the plurality of services based on the set of travel preferences to form the travel itinerary.

5. The method of claim 1, further comprising:
monitoring travel behavior of the user for the time period to determine the pattern of travel behavior;
identifying a plurality of preferences for the user based on the pattern of travel behavior; and
applying a ranking to the plurality of preferences, and
wherein determining the at least one travel preference further comprises determining the at least one travel preference from the plurality of preferences based on the ranking.

6. The method of claim 1, wherein identifying the schedule data further comprises analyzing calendar data associated with the user to identify the schedule data for the event.

7. The method of claim 1, further comprising:
presenting the travel itinerary to the user, and
wherein reserving the one or more services further comprises reserving the one or more services in response to a user input.

8. The method of claim 1, wherein determining the at least one travel preference based on the pattern of travel behavior further comprises determining the at least one travel preference based on at least one of a price preference, an arrival time preference, a rewards program associated with the user, a financial statement, user credentials for travel services, a prior selection of services, a seat selection, an aircraft selection, a checked bag option selection, a seat position selection, a total travel time, and an upgrade selection.

9. The method of claim 1, further comprising:
detecting a change in the one or more services reserved for the user; and
determining a new service for the travel itinerary based on the change, the schedule data, and the set of travel preferences.
automatically reserving the new service.

10. A system for creating a customized travel itinerary, the system comprising:
a network interface to communicate over one or more communication networks;
a processor coupled to the network interface and adapted to execute one or more processes; and
a memory configured to store a process executable by the processor, the process when executed operable to:
identify schedule data for an event associated with a user, the schedule data including information that corresponds to a time of the event and a location of the event;
determine at least one travel preference based on a pattern of travel behavior;
monitor non-travel behavior of the user for a time period to determine a pattern of non-travel behavior;
determine at least one predicted travel preference for the user based on the pattern of non-travel behavior;
determine a set of travel preferences that includes the at least one travel preference and the at least one predicted travel preference;
generate a travel itinerary for the event based on the schedule data and the set of travel preferences, the travel itinerary including one or more services that facilitate attendance at the event; and
reserve the one or more services for the user.

11. The system of claim 10, wherein the process, when executed by the processor, is further operable to:
confirm the at least one predicted travel preference to determine a new travel preference, and
wherein the set of travel preferences includes the new travel preference.

12. The system of claim 10, wherein the set of travel preferences includes a plurality of travel preferences, wherein the process, when executed, is further operable to:
apply a ranking to the set of travel preferences based on respective values associated with each travel preference; and
determine the set of travel preferences based on the ranking.

13. The system of claim 12, wherein the process to generate the travel itinerary for the event is further operable to:
identify a plurality of services that satisfy at least a portion of the set of travel preferences; and
select one or more of the plurality of services based on the set of travel preferences to form the travel itinerary.

14. The system of claim 10, wherein the process, when executed by the processor, is further operable to:
monitor travel behavior of the user for the time period to determine the pattern of travel behavior;
identify a plurality of preferences for the user based on the pattern of travel behavior; and
apply a ranking to the plurality of preferences, and
wherein the process to determine the at least one travel preference is further operable to determine the at least one travel preference from the plurality of preferences based on the ranking.

15. The system of claim 10, wherein the process to identify the schedule data is further operable to analyze calendar data associated with the user to identify the schedule data for the event.

16. A tangible, non-transitory, computer-readable media having instructions encoded thereon, the instructions, when executed by a processor, are operable to:
identify schedule data for an event associated with a user, the schedule data including information that corresponds to a time of the event and a location of the event;
determine at least one travel preference based on a pattern of travel behavior;
monitor non-travel behavior of the user for a time period to determine a pattern of non-travel behavior;
determine at least one predicted travel preference for the user based on the pattern of non-travel behavior;
determine a set of travel preferences that includes the at least one travel preference and the at least one predicted travel preference;
generate a travel itinerary for the event based on the schedule data and the set of travel preferences, the travel itinerary including one or more services that facilitate attendance at the event; and
reserve the one or more services for the user.

17. The tangible, non-transitory, computer-readable media of claim 16, wherein the instructions, when executed by the processor, are further operable to:
confirm the at least one predicted travel preference to determine a new travel preference, and
wherein the set of travel preferences includes the new travel preference.

18. The tangible, non-transitory, computer-readable media of claim 16, wherein the set of travel preferences includes a plurality of travel preferences, wherein the instructions, when executed by the processor, are further operable to:
apply a ranking to the set of travel preferences based on respective values associated with each travel preference; and
determine the set of travel preferences based on the ranking.

19. The tangible, non-transitory, computer-readable media of claim 18, wherein the instructions to generate the travel itinerary for the event are further operable to:
identify a plurality of services that satisfy at least a portion of the set of travel preferences; and
select one or more of the plurality of services based on the set of travel preferences to form the travel itinerary.

20. The tangible, non-transitory, computer-readable media of claim 16, wherein the instructions, when executed by the processor, are further operable to:
monitor travel behavior of the user for the time period to determine the pattern of travel behavior;
identify a plurality of preferences for the user based on the pattern of travel behavior; and
applying a ranking to the plurality of preferences, and
wherein the process to determine the at least one travel preference is further operable to determine the at least one travel preference from the plurality of preferences based on the ranking.
